(19) United States
(12) Patent Application Publication
(10) Pub. No.: US 2008/0256914 A1
(43) Pub. Date: Oct. 23, 2008

(54) Method and device for automatically coupling a combine feeder interface and a combine header via a stationary gearbox

(76) Inventors: Jonathan E. Ricketts, Ephrata, PA (US); Bradley J. Wagner, Wrightsville, PA (US)

Correspondence Address: CNH AMERICA LLC, INTELLECTUAL PROPERTY LAW DEPARTMENT, PO BOX 1895, M.S. 641, NEW HOLLAND, PA, 17557, US

(21) Appl. No.: 11/788,954

(22) Filed: Apr. 23, 2007

(51) Int. Cl. A01D 69/00

(52) U.S. Cl. 56/10.8

(57) ABSTRACT

An automatic coupling and latching assembly, for coupling a combine feeder and a combine header from the cab of a combine harvester, said assembly comprising a stationary gearbox with a telescopic jackshaft assembly extending therefrom, a shift fork activation unit, and comprising spring loaded retainers, is disclosed.

### TECHNICAL FIELD

The present invention relates to the drive-train coupling of combine feeder interfaces and combine headers; and it particularly relates to automatically coupling the same via a stationary gearbox.

### BACKGROUND ART

The combine harvester, or simply combine, is a machine that harvests, threshes, and cleans crops, especially grain plants. The combine was originally patented in 1834 by Hiram Moore, the same year as Cyrus McCormick was granted a patent on the mechanical reaper. Early combines, some of which were quite large, were drawn by horse and mule teams and used a bull wheel to provide mechanical power. Later, tractor-drawn, PTO-powered combines were used. Some combines used shakers to separate the grain from the chaff, and used straw-walkers to eject the straw while retaining the grain. Tractor-drawn combines evolved to have separate gas or diesel engines to power the grain separation. Today's combines are self-propelled and use diesel engines for power. Rotary designed combines were significant advancements in the art in the late 1970s. Today's combines are equipped with removal heads, or headers, designed for particular crops. There is the standard head or grain platform, which is used for many crops including grain, legumes and many seed crops. There are also wheat heads, dummy heads or pickup headers, specialized corn heads, row crop heads, etc. The headers or heads are generally interchangeable and made to fit combine feeder interfaces through which the crop enters the feeder housing and can advance into the combine.

Conventionally, combine feeder housings are equipped with quick-connect coupling mechanisms at the interface between the feeder and the header. The quick-connect mechanism enables an operator, standing outside of the combine, to manually exchange one header for another, and to manually latch the feeder to the header. For example, attached to the back of each header are two (left and right of center) quick-connect latches. Attaching the combine feeder housing to these header latches is accomplished by an operator driving the combine up to a header, hydraulically lowering the combine's feeder housing, and driving the combine forward until the feeder housing's interface, which is equipped with two quick-connect yokes, contacts the header latches. Then the combine's feeder housing is hydraulically lifted, allowing the quick-connect yokes, on the feeder interface, to slide up and against the quick-connect latches on the header, and thereafter the header can be raised in concert with raising the feeder. However, it is still necessary thereafter for the operator to leave the cab in order to latch and lock the drive train. That is, the operator must connect, by hand, various drive belts, chains, and hydraulic hoses in order to couple the header drives with the feeder drives.

In co-pending application Ser. No. 11/483,926, filed Jul. 10, 2006, there is disclosed an automatic header latching mechanism for connecting the feeder drive and header drive. However its operation requires that the gearbox slide back and forth along the feeder interface.

A new coupling device which negates manual intervention, during the feeder housings coupling to and uncoupling from the combine header drive mechanisms, using a stationary gearbox, would satisfy a longfelt need, and represent a surprising advancement in the art.

### SUMMARY OF THE INVENTION

The present invention permits a combine operator to automatically connect the combine's feeder PTO shaft to the combine's header drive shafts without leaving the cab of the combine. This automatic coupling device comprises a stationary in-line gearbox having a telescopically extendible jack shaft, which jack shaft's telescopic action is initiated by a shift fork assembly having pneumatic, electronic and/or hydraulic actuators triggered from the cab of the combine. The telescopic jack shaft rotatably extends from the gearbox, in-line along either side of the feeder interface, so as to be in alignment with and engageable to an oversized receivable coupler element, which coupler transfers power from the feeder drive to the header drive. In alignment therewith, but extending from the opposite side of the feeder housing from where the gearbox is located, there may be a second but longer shaft extending from the gearbox to a point where it is insertable in a matching oversize receivable coupler element. Said second but longer shaft may also be telescopically actuated by a fork shift, as a first coupling, to extend into the oversized receivable or second coupling member.

The header can be lifted by driving a combine up to it and lifting its feeder. When the feeder is lifted, the header's interface tilts into the feeder adapter interface, is latched, and the drives can then be coupled from the instrument panel in the cab of the combine.

The telescopic jack shafts on the gearbox, when actuated by shift fork assemblies, will engage the oversized receivable header coupler members on both sides of the feeder. The shift fork assemblies can also activate a header latch pin locking and unlocking mechanism which cooperates along a line substantially parallel to but separate from the gearbox line. The couplings of the present invention can be spring-loaded to fully engage or disengage from the header drive shafts as a consequence of slowly rotating the combine feeder drive shaft in one direction or the other. Electronic initiation and modulation will safeguard against either premature engagement or premature disengagement of the latching and coupling system.

### BRIEF DESCRIPTION OF THE DRAWINGS

FIG. 1 is a side view of a combine harvester coupled to a header with the coupling mechanism of the present invention mounted on one side of the combine's feeder housing interface with the header;

FIG. 2 is a close-up frontal view of the coupling mechanism of the present invention, showing the telescopic jack shaft extending from the gearbox, through the shift fork, and entering the receivable coupling members located on a header drive line;

FIG. 3 is a right frontal perspective view of the device of the present invention secured to the feeder interface of a combine harvester, prior to coupling with a header;

FIG. 4 is a direct frontal view of the device of the present invention and the feeder interface uncoupled from the header drive;

FIG. 5 is a direct frontal views of the device of the present invention and the feeder interface, when coupled to the header drive;

FIG. 6 is a direct frontal view of the feeder interface and the device of the present invention with the latch pin unlatched;

FIG. 7 is a bottom view of the latch pin cable and uncoupled device of the present invention;

FIG. 8 is a perspective view of the bottom of the shift fork element of the present invention; and

FIG. 9 is a top view of a single cylinder and pivot arm embodiment for actuating the shift fork of the present invention.

### DETAILED DESCRIPTION OF THE INVENTION

It should be understood that the detailed description below while indicating preferred embodiments of the invention, is given by way of illustration only, since various changes and modifications within the spirit and scope of the invention will become apparent to those skilled in the art from this detailed description. Embodiments of the invention will be described below with reference to the drawings.

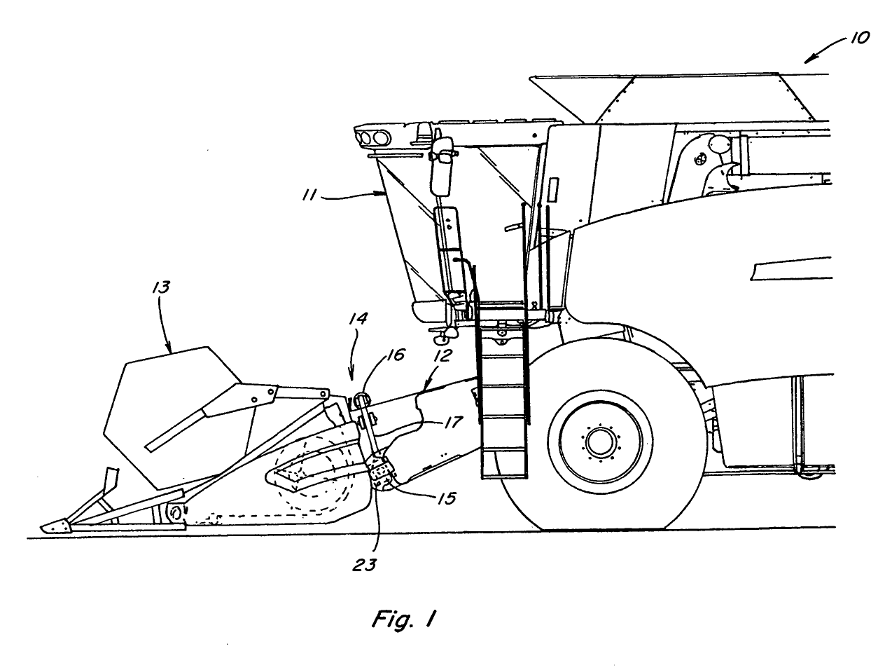

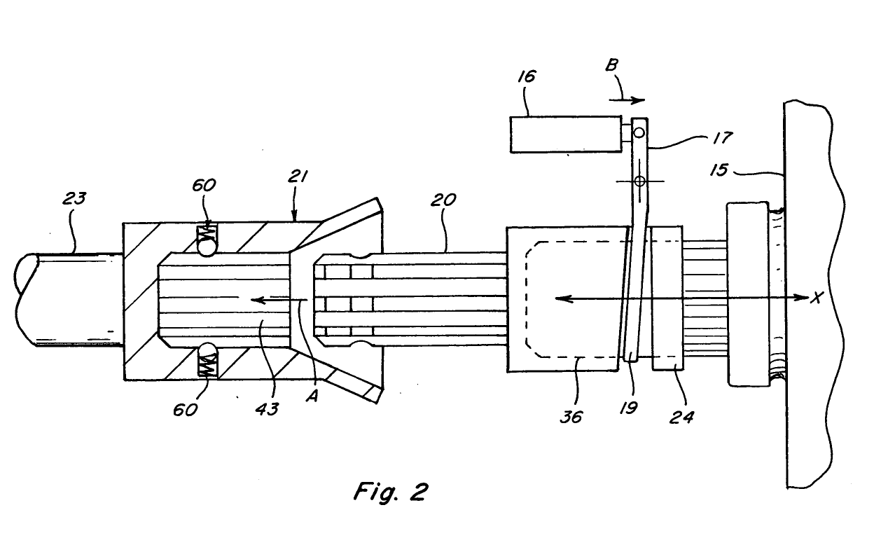

Referring now to FIGS. 1, 2 and 3, in accordance with the present invention, combine harvester 10 can be driven up to and can lift header 13, and from cab 11 activate shift fork assembly 14 by pushing a button or throwing a switch or touching a screen to cause the header 13 and feeder 12 to couple their respective drive trains to one another. That is to say, cylinder 16, by opening and closing, causes its plunger arms at 18 to move shift fork element 17 in the direction B to effectively couple the feeder 12, via shaft 20, to the header 13, via oversized receivable coupling member 21, and effectively connecting the drive from gearbox 15 with the header drive line 23. The combine's drive power is transferred via gearbox 15, as shown in FIG. 2, to a short jackshaft 24, which is splined in order to engagingly receive a matingly splined sleeve 36 having another splined jackshaft 20 extending from sleeve 36, which together with sleeve 36 can telescopically extend the reach of jackshaft 24. Together these telescopically extendable elements 20 and 36 form a first coupling member and are engagingly extending the drive power of a combine feeder drive line 24. The combine header drive line 23 has affixed at its distal end, a second coupling member known as the oversized receivable element 21 which has an enlarged angular mouth and an internally splined socket 43 for matingly and engagingly receiving jackshaft 20. Actuator cylinder 16 is controlled from cab 11 so as to move the top of shift fork 17 in the direction of B, which will tilt the bottom 47 of shift fork 17, to telescopically move the first coupling member via shaft 20 in the direction A towards socket 43 of the header drive line 23. It is also noted that spring loaded retainers 60 and 61 will serve to secure the connection between the splined shaft and the matingly splined receivable socket 43.

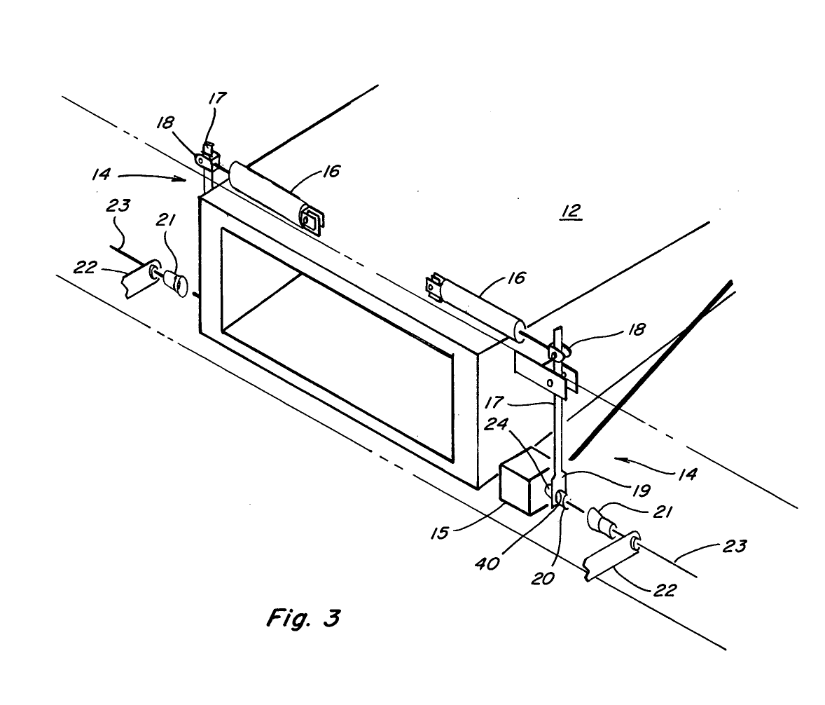

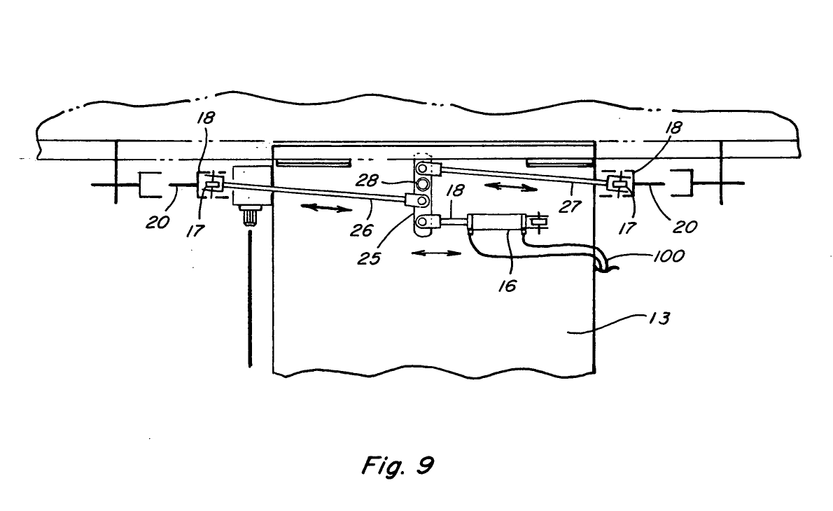

Referring now more specifically to FIG. 3, the elements of the shift fork assembly 14 to be affixed along the two opposite sides of the feeder housing 12 interface are shown. That is, gearbox 15 is stably fixed at the right bottom side of the feeder 12 inlet or as we have previously referred to it, the interface. Gearbox 15 is fixedly secured, at the combine's feeder 12 interface, against moving in any direction which would be coaxial with the drive shafts extending from the gearbox. The hydraulic cylinders 16 may be positioned at the top of the feeder housing 12 interface with rods 18 extending therefrom laterally to connect with shift forks 17 that extend downwardly from the rod 18 and cylinder 16 actuators. Alternatively, (as in FIG. 9) there may be a single actuator cylinder 16, having pivot arm 25 for actuating the first coupling jack shaft 20 on each side of feeder 13. At the bottom of shift forks 17 are the fork sections having prongs 19 which define an opening 40 (See FIG. 8). Short jackshaft 24 extends from gearbox 15 in the direction of shift fork 17, through opening 40 while long shaft 50 extends from gearbox 15 in the opposite direction. Drive line 23 of the header 13 is supported by bracket 22 of the header. Telescopic shaft 20 having splines is insertable into the receivable mouth 21 having matching splines, enabling secure transfer of power to drive shaft 23. Thus, the header drive 23 and the feeder drive extension short jackshaft 24 and longer shaft 50 may be coupled via the insertion of shaft 20 into the receivable mouth 21 of header shaft 23. Cylinder 16 is actuated to pull shift fork 17 at its top end allowing its bottom end to shift shaft 20 into socket 21.

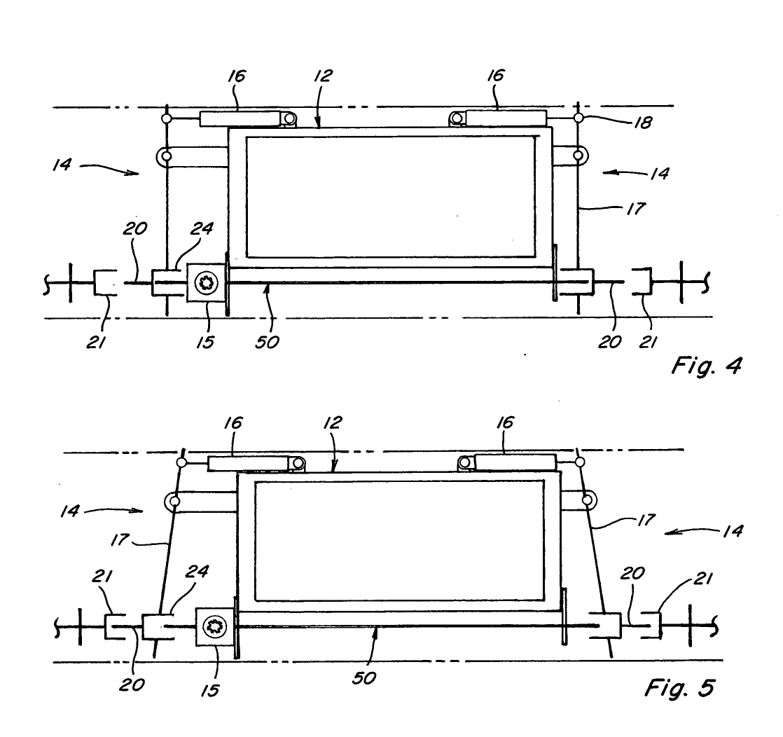

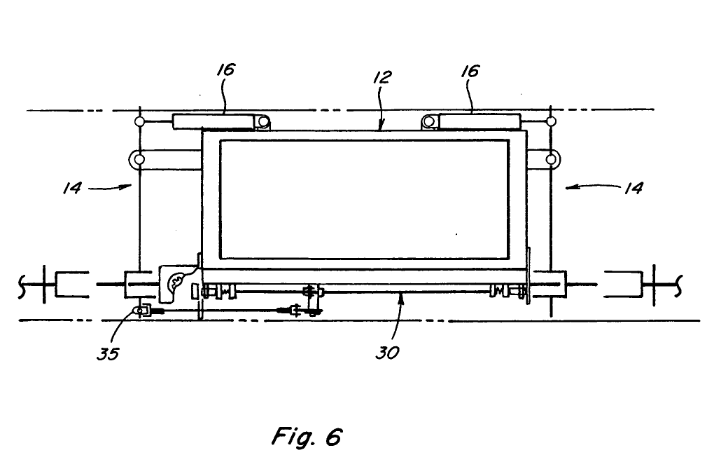

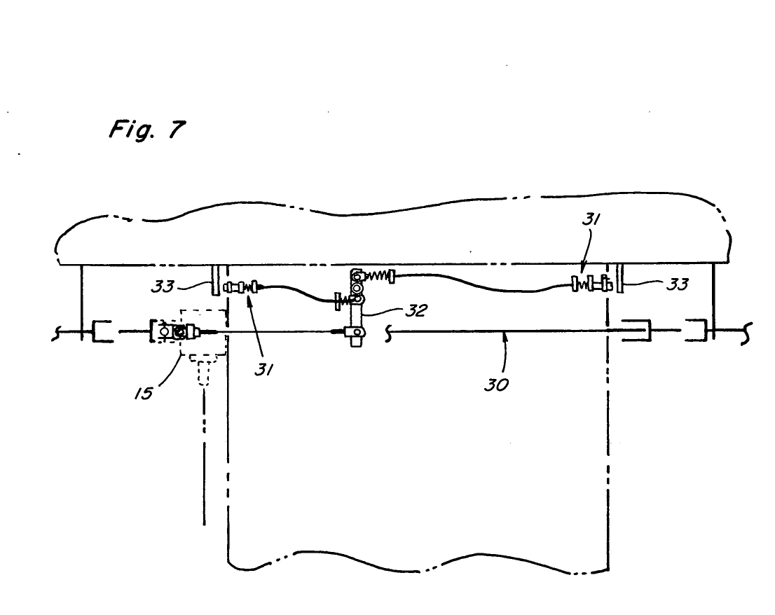

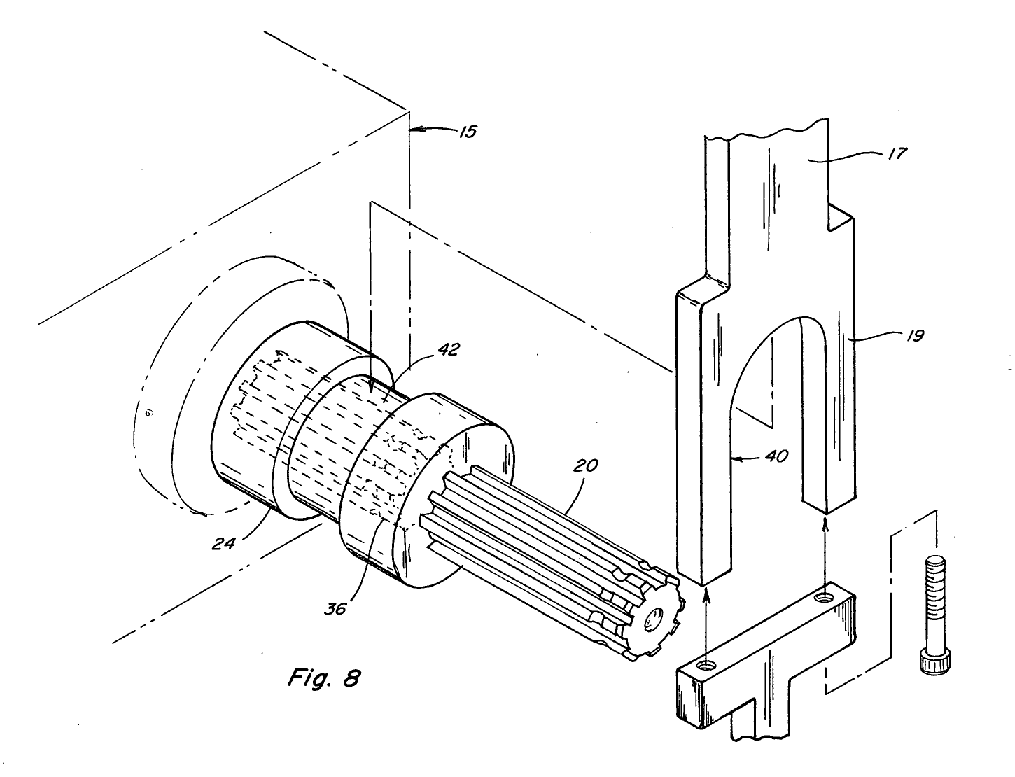

FIGS. 4 and 5 are schematic front views of the feeder housing 12 interface together with the coupling and latching devices generally shown at 14. As can be seen in FIG. 4, prior to actuation of cylinder 16, when shift fork 17 is at rest, 20 and 21 are uncoupled. As can be seen in FIG. 5, once cylinder 16 is actuated, causing shift fork 17 to shift, then shaft 20 couples with socket 21. These actions are complimented with the coinciding action of the latch cable 30 as can be seen in FIGS. 6 and 7, which is in an unlatched position in FIG. 6 but will move into latched position by virtue of pin 35 which will move laterally to latch with the header hooks (not shown) upon actuation of cylinders 16.

Although the invention has been described in its preferred form with a certain degree of particularity, it is understood that the structure of the preferred form may be changed in the details of construction in that the combination and arrangement of parts may be modified without departing from the spirit and scope of the invention as is hereinafter claimed. Additional concepts based upon this description may be employed in other embodiments without departing from the scope of the invention. Accordingly, the following claims are intended to protect the invention broadly as well as in the specific form shown.

What is claimed is:

1. A combine harvester header/feeder automatic latching and drive-coupling device comprising:
a) an in-line gearbox fixedly secured at the feeder interface, against motion which would be coaxial with drive shafts extending therefrom; and
b) said first coupling member comprising a short jack shaft extending from said gearbox along a line coaxially directed towards a second coupling member which is an extension of a drive shaft of the header; and
c) said first coupling member having a matingly splined sleeve having extending therefrom a first short jack shaft extension extending in-line from said sleeve along an axis coaxial with said first jack shaft enabling a telescopic extension of the first coupling member; and having a second longer shaft member extending coaxially and in-line with the first short jack shift fork from an opposite side of the gearbox from which the first short jack shaft extends; and
d) said second coupling member being defined at its distal end by a receivable oversized mouth portion of said coupler, and being matingly splined to receive and secure the telescopically extending first coupling member into said second coupling member; and
e) said first coupling members telescopic movement being actuated by a cylinder member whose action is controlled by an on/off element inside of a cab portion of the combine harvester.

2. The automatic latching and coupling device of claim 1 having shift fork elements which upon activation by the on/off element moves the first coupling members to either engage or disengage the second coupling member.

3. The automatic device of claim 1 having cooperating latch pins and hooks for locking the combine feeder to the combine header, which cooperating latch pins are actuated by the same shift forks which actuate the combine couplers.

4. The automatic device of claim 1 wherein a separate cylinder actuates the short jack shaft engagement from the cylinder which actuates the longer shaft engagement.

5. The automatic device of claim 1 wherein a single cylinder and pivot arm actuates both the short jack shaft and the longer jack shaft.
